(19) United States
(12) Patent Application Publication
(10) Pub. No.: US 2020/0274191 A1
(43) Pub. Date: Aug. 27, 2020

(54) METHOD FOR PRODUCING LITHIUM-ION RECHARGEABLE BATTERY, AND LITHIUM-ION RECHARGEABLE BATTERY

(71) Applicant: SHOWA DENKO K.K., Tokyo (JP)

(72) Inventors: Takaki YASUDA, Ichihara-shi, Chiba (JP); Akira SAKAWAKI, Ichihara-shi, Chiba (JP); Tatsunori SHINO, Ichihara-shi, Chiba (JP)

(73) Assignee: SHOWA DENKO K.K., Tokyo (JP)

(21) Appl. No.: 16/646,708

(22) PCT Filed: Jul. 23, 2018
(86) PCT No.: PCT/JP2018/027532

§ 371 Date: Mar. 12, 2020

(30) Foreign Application Priority Data
Oct. 19, 2017 (JP) 2017-202585

(51) Int. Cl. H01M 10/0525; H01M 10/0562; H01M 4/485; H01M 4/62; H01M 10/0585

(52) U.S. Cl. CPC H01M 10/0525; H01M 10/0562; H01M 2004/028; H01M 4/62; H01M 10/0585; H01M 4/485

(57) ABSTRACT

A lithium-ion rechargeable battery (1) including: a substrate (10); a negative electrode collector layer (20) made of metal; a negative electrode layer (30) containing a negative-electrode active material; a solid electrolyte layer (40) containing an inorganic solid electrolyte; a positive electrode layer (60) containing a positive-electrode active material and the inorganic solid electrolyte; and a mixture layer (50) containing the positive-electrode active material and the inorganic solid electrolyte provided between the solid electrolyte layer (40) and the positive electrode layer (60), the ratio of the positive-electrode active material therein being lower than that in the positive electrode layer (60). Also disclosed is a method for producing a lithium-ion rechargeable battery.

### TECHNICAL FIELD

The present invention relates to a method for producing a lithium-ion rechargeable battery and the lithium-ion rechargeable battery.

### BACKGROUND ART

With the popularization of the mobile electronic devices, such as the mobile phones or the laptop computers, development of a compact and lightweight rechargeable battery having high energy density is strongly desired. As a rechargeable battery satisfying such requirements, a lithium-ion rechargeable battery is known. The lithium-ion rechargeable battery includes a positive electrode containing a positive-electrode active material, a negative electrode containing a negative-electrode active material, and an electrolyte having lithium-ion conductivity and interposed between the positive electrode and the negative electrode.

In the conventional lithium-ion rechargeable battery, an organic electrolytic solution or the like was used as the electrolyte. In contrast thereto, an all-solid-state and thin-film-type lithium-ion rechargeable battery, which uses a solid electrolyte composed of an inorganic material (inorganic solid electrolyte) as the electrolyte and configures all of the negative electrode, the solid electrolyte and the positive electrode with thin films, has been suggested (refer to Patent Document 1).

### CITATION LIST

### Patent Literature

Patent Document 1: Japanese Patent Application Laid-Open Publication No. 2013-73846

### SUMMARY OF INVENTION

### Technical Problem

Here, the lithium-ion rechargeable battery is strongly desired to increase battery capacity (discharge capacity) capable of outputting to the outside per a single charge.

However, in the lithium-ion rechargeable battery using an inorganic solid electrolyte instead of an electrolytic solution, a region having a low degree of lithium-ion conductivity existed on a boundary portion (an interface) between the inorganic solid electrolyte and the positive electrode, and the discharge capacity of the battery became lower than that of the lithium-ion rechargeable battery using the electrolytic solution in some cases.

An object of the present invention is to increase a discharge capacity of a lithium-ion rechargeable battery using an inorganic solid electrolyte.

### Solution to Problem

A method for producing a lithium-ion rechargeable battery according to the present invention includes: a solid electrolyte layer formation process forming a solid electrolyte layer containing an inorganic solid electrolyte having lithium-ion conductivity; and a positive electrode layer formation process implanting a positive-electrode active material into the solid electrolyte layer and forming a positive electrode layer containing the inorganic solid electrolyte and the positive-electrode active material in mixture on the solid electrolyte layer.

In such a method for producing a lithium-ion rechargeable battery, a ratio of the positive-electrode active material in the solid electrolyte layer is lower than a ratio of the positive-electrode active material in the positive electrode layer.

Moreover, the inorganic solid electrolyte contains LiₓP_{y}O_{z} (x≠0, y≠0, z≠0), and the positive-electrode active material contains LiₐM_{b}O_{c} (M is a transition metal, a≠0, b≠0, c≠0).

Further, the positive-electrode active material contains an element heavier than an element contained in the inorganic solid electrolyte.

Moreover, from another standpoint, a lithium-ion rechargeable battery according to the present invention includes: a solid electrolyte layer containing an inorganic solid electrolyte having lithium-ion conductivity; a mixture layer containing a positive-electrode active material and the inorganic solid electrolyte in mixture; and a positive electrode layer containing the positive-electrode active material and the inorganic solid electrolyte in mixture, a ratio of the positive-electrode active material in the positive electrode layer being higher than a ratio of the positive-electrode active material in the mixture layer.

In such a lithium-ion rechargeable battery, the inorganic solid electrolyte contains LiₓP_{y}O_{z} (x≠0, y≠0, z≠0), and the positive-electrode active material contains LiₐM_{b}O_{c} (M is a transition metal, a≠0, b≠0, c≠0).

Further, in the positive electrode layer, the positive-electrode active material is crystallized and the inorganic solid electrolyte is amorphized.

Still further, in the positive electrode layer, particles composed of the positive-electrode active material are dispersed into a base material composed of the inorganic solid electrolyte.

Then, the positive electrode layer contains the LiₐM_{b}O_{c} more than the LiₓP_{y}O_{z} in a molar ratio.

### Advantageous Effects of Invention

According to the present invention, it is possible to increase a discharge capacity of a lithium-ion rechargeable battery using an inorganic solid electrolyte.

### BRIEF DESCRIPTION OF DRAWINGS

FIG. 1 is a diagram showing a cross-sectional configuration of a lithium-ion rechargeable battery to which the exemplary embodiment of the present invention is applied;

FIG. 2 is a flowchart showing a method of producing the lithium-ion rechargeable battery of the exemplary embodiment;

FIGS. 3A and 3B are diagrams for illustrating a structure of a lithium-ion rechargeable battery of Example;

FIGS. 4A and 4B are diagrams for illustrating a structure of a lithium-ion rechargeable battery of Comparative example;

FIGS. 5A and 5B are diagrams for illustrating a structure of a positive electrode layer of the lithium-ion rechargeable battery of Example; and

FIG. 6A is a diagram showing charge-discharge characteristics of the lithium-ion rechargeable battery of Example and FIG. 6B is a diagram showing charge-discharge characteristics of the lithium-ion rechargeable battery of Comparative example.

### DESCRIPTION OF EMBODIMENTS

Hereinafter, an exemplary embodiment according to the present invention will be described in detail with reference to attached drawings. Note that the size, thickness or the like of each component in the drawings referenced in the following description will differ from the actual dimension in some cases.

### [Configuration of Lithium-Ion Rechargeable Battery]

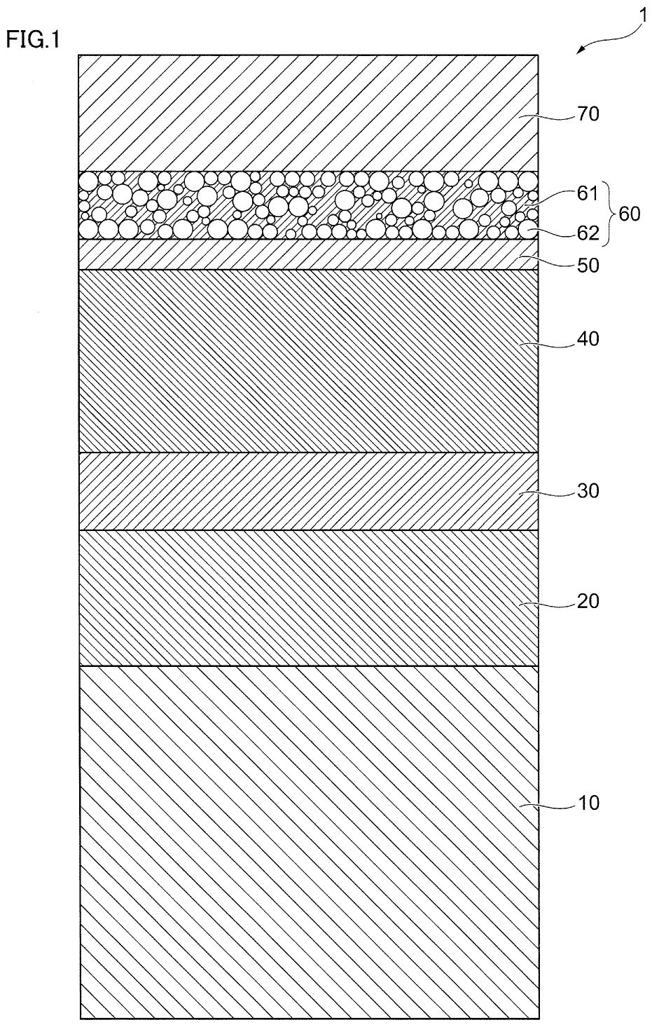

FIG. 1 is a diagram showing a cross-sectional configuration of a lithium-ion rechargeable battery 1 to which the exemplary embodiment is applied.

The lithium-ion rechargeable battery 1 includes: a substrate 10; and a negative electrode collector layer 20, a negative electrode layer 30, a solid electrolyte layer 40, a mixture layer 50, a positive electrode layer 60 and a positive electrode collector layer 70 that are laminated on the substrate 10 in this order.

Next, each constituent of the lithium-ion rechargeable battery 1 of the exemplary embodiment will be described in more detail.

### (Substrate)

As the substrate 10, not particularly limited, those configured with various materials, such as metal, glass, ceramics, resin and so on can be used.

### (Negative Electrode Collector Layer)

The negative electrode collector layer 20 is not particularly limited as long as being a solid thin film having electron conductivity, and it is possible to use, for example, metals such as titanium (Ti), aluminum (Al), copper (Cu), platinum (Pt), gold (Au), silver (Ag), stainless steel, iron (Fe), nickel (Ni), indium (In), tantalum (Ta), hafnium (Hf), zirconium (Zr) or tungsten (W), or conductive materials containing alloys of these metals or ITO (Indium Tin Oxide).

The thickness of the negative electrode collector layer 20 can be set in the range of, for example, 5 nm or more and 50 μm or less. When the thickness of the negative electrode collector layer 20 is less than 5 nm, the power collection function is deteriorated, to thereby become impractical. On the other hand, if the thickness of the negative electrode collector layer 20 exceeds 50 μm, despite the electrical characteristics not being greatly different, it takes too much time to form the layer, and thereby, the productivity is deteriorated.

Moreover, as the manufacturing method of the negative electrode collector layer 20, known deposition methods, such as various kinds of PVD or various kinds of CVD, may be used; however, in terms of production efficiency, it is desirable to use the sputtering method or the vacuum deposition method.

### (Negative Electrode Layer)

The negative electrode layer 30 is a solid thin film and contains a negative-electrode active material that occludes lithium ions in charging and releases lithium ions in discharging. Here, as the negative-electrode active material constituting the negative electrode layer 30, for example, carbon (C) or silicon (Si) can be used. Moreover, the negative electrode layer 30 may be added with various kinds of dopants.

Note that, in manufacturing the lithium-ion rechargeable battery 1 of the exemplary embodiment, formation (deposition) of the negative electrode layer 30 is not essential. For example, in manufacturing, a method can be adopted in which the solid electrolyte layer 40 is formed on the negative electrode collector layer 20 without forming the negative electrode layer 30 and the negative electrode layer 30 is formed (separated) between the negative electrode collector layer 20 and the solid electrolyte layer 40 by charge-discharge operation performed after deposition. In this case, the negative electrode layer 30 is composed of lithium (Li).

The thickness of the negative electrode layer 30 in the case of forming thereof by deposition can be set in the range of, for example, 10 nm or more and 40 μm or less. When the thickness of the negative electrode layer 30 is less than 10 nm, the capacity of the lithium-ion rechargeable battery 1 to be obtained becomes too small, and impractical. On the other hand, when the thickness of the negative electrode layer 30 exceeds 40 μm, it takes too much time to form the layer, and thereby, the productivity is deteriorated. However, when the battery capacity required of the lithium-ion rechargeable battery 1 is large, the thickness of the negative electrode layer 30 may exceed 40 μm.

Moreover, it does not matter whether the negative electrode layer 30 includes crystal structures or is in the amorphous state without including the crystal structures; however, in the point that expansion and contraction associated with occluding and releasing of lithium ions are more isotropic, it is preferable that the negative electrode layer 30 is in the amorphous state.

Further, as the manufacturing method of the negative electrode layer 30, known deposition methods, such as various kinds of PVD or various kinds of CVD, may be used; however, in terms of production efficiency, it is desirable to use the sputtering method.

### (Solid Electrolyte Layer)

The solid electrolyte layer 40 is a solid thin film and contains a solid electrolyte made of an inorganic material (inorganic solid electrolyte). The inorganic solid electrolyte constituting the solid electrolyte layer 40 is not particularly limited as long as having lithium-ion conductivity, and those configured with various kinds of materials, such as oxides, nitrides or sulfides, may be used.

The thickness of the solid electrolyte layer 40 can be set in the range of, for example, 10 nm or more and 10 μm or less. When the thickness of the solid electrolyte layer 40 is less than 10 nm, in the obtained lithium-ion rechargeable battery 1, a short circuit (leakage) between the positive electrode layer 60 and the negative electrode layer 30 is likely to occur. On the other hand, when the thickness of the solid electrolyte layer 40 exceeds 10 μm, the moving distance of lithium ion is elongated, and thereby, the charge and discharge rate is reduced.

Moreover, it does not matter whether the solid electrolyte layer 40 includes crystal structures or is in the amorphous state without including the crystal structures; however, in the point that expansion and contraction due to heat are more isotropic, it is preferable that the solid electrolyte layer 40 is in the amorphous state.

Further, as the manufacturing method of the solid electrolyte layer 40, known deposition methods, such as various kinds of PVD or various kinds of CVD, may be used; however, in terms of production efficiency, it is desirable to use the sputtering method.

### (Mixture Layer)

The mixture layer 50 is a solid thin film and contains a positive-electrode active material that releases lithium ions in charging and occludes lithium ions in discharging and a solid electrolyte composed of an inorganic material (inorganic solid electrolyte). Consequently, the mixture layer 50 of the exemplary embodiment is composed of a composite electrode containing the positive-electrode active material and the inorganic solid electrolyte. Here, it is desirable that the inorganic solid electrolyte contained in the mixture layer 50 is the same as that contained in the solid electrolyte layer 40.

The thickness of the mixture layer 50 can be set in the range of, for example, 1 nm or more and 100 nm or less. When the thickness of the mixture layer 50 is less than 1 nm, effects of reducing the resistance between the solid electrolyte layer 40 and the positive electrode layer 60 become unavailable. On the other hand, when the thickness of the mixture layer 50 exceeds 100 nm, insulation resistance between the negative electrode layer 30 and the positive electrode layer 60 is reduced.

Moreover, as the preparation method of the mixture layer 50, known deposition methods, such as various kinds of PVD or various kinds of CVD, may be used; however, in terms of production efficiency, it is desirable to use the sputtering method. Further, as the preparation method of the mixture layer 50, the layer may be independently manufactured; however, from the viewpoint of production efficiency, it is desirable that the mixture layer 50 be secondarily formed in the process of laminating the positive electrode layer 60 on the solid electrolyte layer 40.

### (Positive Electrode Layer)

The positive electrode layer 60 is a solid thin film and contains a positive-electrode active material that releases lithium ions in charging and occludes lithium ions in discharging and a solid electrolyte composed of an inorganic material (inorganic solid electrolyte). Consequently, similar to the mixture layer 50, the positive electrode layer 60 of the exemplary embodiment is composed of a composite electrode containing the positive-electrode active material and the inorganic solid electrolyte. Here, it is desirable that the positive-electrode active material and the inorganic solid electrolyte contained in the positive electrode layer 60 are the same as those contained in the mixture layer 50.

Moreover, the positive electrode layer 60 of the exemplary embodiment includes a solid electrolyte region 61 mainly containing the inorganic solid electrolyte and a positive electrode region 62 mainly containing the positive-electrode active material. Then, in the positive electrode layer 60, the inorganic solid electrolyte constituting the solid electrolyte region 61 and the positive-electrode active material constituting the positive electrode region 62 are mixed while each of which maintains itself. As a result, in the positive electrode layer 60, one of them serves as the matrix (the base material) and the other serves as the fillers (the particles). Here, in the positive electrode layer 60, it is desirable that the solid electrolyte region 61 serves as the matrix and the positive electrode region 62 serves as the fillers.

The thickness of the positive electrode layer 60 can be set in the range of, for example, 10 nm or more and 100 μm or less. When the thickness of the positive electrode layer 60 is less than 10 nm, the capacity of the lithium-ion rechargeable battery 1 to be obtained becomes too small, and impractical. On the other hand, when the thickness of the positive electrode layer 60 exceeds 100 μm, it takes too much time to form the layer, and thereby, the productivity is deteriorated. However, when the battery capacity required of the lithium-ion rechargeable battery 1 is large, the thickness of the positive electrode layer 60 may exceed 100 μm.

Moreover, as the preparation method of the positive electrode layer 60, known deposition methods, such as various kinds of PVD or various kinds of CVD, may be used; however, in terms of production efficiency, it is desirable to use the sputtering method.

### [Solid Electrolyte Region]

The solid electrolyte region 61 mainly contains the inorganic solid electrolyte. As the inorganic solid electrolyte constituting the solid electrolyte region 61, for example, a material composed of lithium phosphorous oxide (LiₓP_{y}O_{z}: x≠0, y≠0, z≠0) can be used.

Moreover, it does not matter whether the solid electrolyte region 61 includes crystal structures or amorphous structures; however, in the point that lithium-ion conductivity is increased, it is preferable that the solid electrolyte region 61 has the amorphous structures (having been amorphized).

### [Positive Electrode Region]

The positive electrode region 62 mainly contains the positive-electrode active material. Here, as the positive-electrode active material constituting the positive electrode layer 60, for example, a material composed of lithium transition metal oxide (LiₐM_{b}O_{c}: a≠0, b≠0, c₀) containing lithium (Li), at least one kind of metal (referred to as M) selected from various kinds of transition metals and oxygen (O) can be used.

Moreover, it does not matter whether the positive electrode region 62 includes crystal structures or amorphous structures; however, in the point that the potential of lithium ions occluded or separated is constant, it is preferable that the positive electrode region 62 has the crystal structures (having been crystallized). [Relationship between solid electrolyte region and positive electrode region]

Here, in the positive electrode layer 60 of the exemplary embodiment, it is preferable that the inorganic solid electrolyte is amorphized in the solid electrolyte region 61 and the positive-electrode active material is crystallized in the positive electrode region 62.

Moreover, in the positive electrode layer 60 of the exemplary embodiment, it is preferable to cause the solid electrolyte region 61 containing the inorganic solid electrolyte to serve as the matrix (base material) and to cause the positive electrode region 62 containing the positive-electrode active material to be dispersed as the fillers (particles).

Further, in the positive electrode layer 60 of the exemplary embodiment, for example, in the case where the solid electrolyte region 61 is composed of the phosphorous oxide (LiₓP_{y}O_{z}) and the positive electrode region 62 is composed of the lithium transition metal oxide (LiₐM_{b}O_{c}), it is preferable to contain the lithium transition metal oxide more than the lithium phosphorous oxide in a molar ratio.

### (Positive Electrode Collector Layer)

The positive electrode collector layer 70 is not particularly limited as long as being a solid thin film having electron conductivity, and it is possible to use, for example, metals such as titanium (Ti), aluminum (Al), copper (Cu), platinum (Pt) or gold (Au), or conductive materials containing alloys of these metals.

The thickness of the positive electrode collector layer 70 can be set in the range of, for example, 5 nm or more and 50 μm or less. When the thickness of the positive electrode collector layer 70 is less than 5 nm, the power collection function is deteriorated, to thereby become impractical. On the other hand, when the thickness of the positive electrode collector layer 70 exceeds 50 μm, it takes too much time to form the layer, and thereby, the productivity is deteriorated.

Moreover, as the manufacturing method of the positive electrode collector layer 70, known deposition methods, such as various kinds of PVD or various kinds of CVD, may be used; however, in terms of production efficiency, it is desirable to use the sputtering method or the vacuum deposition method.

(Relationship between Inorganic Solid Electrolyte and Positive-Electrode Active Material)

As described above, in the lithium-ion rechargeable battery 1 of the exemplary embodiment, the mixture layer 50 and the positive electrode layer 60 contain the positive-electrode active material, and the solid electrolyte layer 40, the mixture layer 50 and the positive electrode layer 60 contain the inorganic solid electrolyte. Here, from a viewpoint of easily realizing formation of the secondary mixture layer 50, it is desirable that the positive-electrode active material contains an element heavier than the inorganic solid electrolyte.

Relationship between Mixture Layer and Positive electrode layer)

Moreover, in the lithium-ion rechargeable battery 1 of the exemplary embodiment, the mixture layer 50 and the positive electrode layer 60 share the point of containing the inorganic solid electrolyte and the positive-electrode active material. However, it is preferable that the mixture layer 50 has a ratio of positive-electrode active material (positive-electrode active material/(positive-electrode active material+inorganic solid electrolyte)) lower than that of the positive electrode layer 60. Note that, regarding the positive electrode layer 60, it is preferable that the ratio of the inorganic solid electrolyte and the positive-electrode active material (inorganic solid electrolyte: positive-electrode active material) is in the range of 1:3 to 1:6 in the molar ratio.

### [Operation of Lithium-Ion Rechargeable Battery]

In the case where the lithium-ion rechargeable battery 1 of the exemplary embodiment is to be charged, a negative electrode of a DC power supply is connected to the substrate 10, and a positive electrode of the DC power supply is connected to the positive electrode collector layer 70. Then, a potential difference occurs between the positive electrode layer 60 and the negative electrode layer 30, and the lithium ions constituting the positive-electrode active material in the positive electrode layer 60 (and the mixture layer 50) are moved to the negative electrode layer 30 through the solid electrolyte layer 40, to be thereby contained by the negative-electrode active material in the negative electrode layer 30.

Moreover, when the lithium-ion rechargeable battery 1 having been charged is to be used (discharged), a negative electrode of a DC load is connected to the substrate 10 and a positive electrode of the DC load is connected to the positive electrode collector layer 70. Then, the lithium ions contained in the negative-electrode active material in the negative electrode layer 30 are moved to the positive electrode layer 60 (and the mixture layer 50) through the solid electrolyte layer 40, to thereby constitute the positive-electrode active material in the positive electrode layer 60 (and the mixture layer 50).

### [Method for Producing Lithium-Ion Rechargeable Battery]

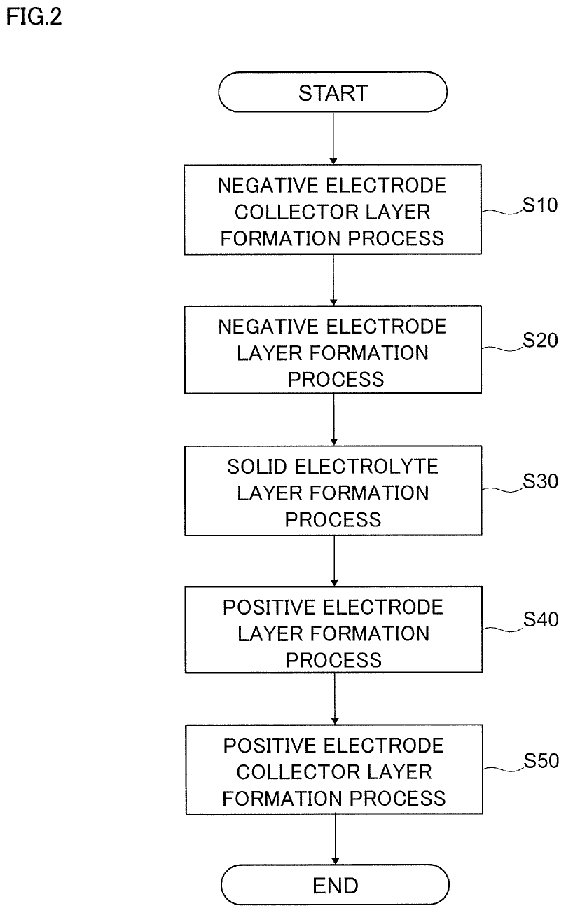

FIG. 2 is a flowchart showing a method of producing the lithium-ion rechargeable battery 1 of the exemplary embodiment.

First, a negative electrode collector layer formation process that forms the negative electrode collector layer 20 is performed on the substrate 10 (step 10).

Next, a negative electrode layer formation process that forms the negative electrode layer 30 is performed on the negative electrode collector layer 20 (step 20).

Subsequently, a solid electrolyte layer formation process that forms the solid electrolyte layer 40 is performed on the negative electrode layer 30 (step 30).

Next, a positive electrode layer formation process that forms the positive electrode layer 60 is performed on the solid electrolyte layer 40 (step 40). Here, in the exemplary embodiment, in the positive electrode layer formation process of step 40, implantation of the positive-electrode active material is performed in a region of the solid electrolyte layer 40 positioned closer to the positive electrode layer 60. As a result, part of the solid electrolyte layer 40 formed in the solid electrolyte layer formation process of step 30 becomes the mixture layer 50 containing the inorganic solid electrolyte and the positive-electrode active material in the positive electrode layer formation process of step 40.

Thereafter, a positive electrode collector layer formation process that forms the positive electrode collector layer 70 is performed on the positive electrode layer 60 (step 50).

Through the above respective processes, the lithium-ion rechargeable battery 1 formed by laminating the negative electrode collector layer 20, the negative electrode layer 30, the solid electrolyte layer 40, the mixture layer 50, the positive electrode layer 60 and the positive electrode collector layer 70 on the substrate 10 in this order is obtained.

Note that, in the positive electrode layer formation process of step 40, due to implantation of the positive-electrode active material into the solid electrolyte layer 40, an interface between the inorganic solid electrolyte constituting the solid electrolyte layer 40 and the inorganic solid electrolyte contained in the positive electrode layer 60 is broken, and thereby the resistance between the solid electrolyte layer 40 and the positive electrode layer 60 is reduced.

### [Others]

In the exemplary embodiment, the negative electrode collector layer 20 was provided between the substrate 10 and the negative electrode layer 30; however, in the case where the substrate 10 is configured with a conductor made of metal or the like, the negative electrode collector layer 20 may be omitted because the substrate 10 can also has the function of the negative electrode collector.

Moreover, in the exemplary embodiment, in the production of the lithium-ion rechargeable battery 1 by use of a lamination process, the negative electrode layer 30 was laminated on the negative electrode collector layer 20 and the solid electrolyte layer 40 was laminated on the negative electrode layer 30; however, the process is not limited thereto. For example, it is possible to directly laminate the solid electrolyte layer 40 on the negative electrode collector layer 20 (the negative electrode layer 30 is not laminated).

In the case where such a configuration is adopted, when the obtained lithium-ion rechargeable battery 1 is charged for the first time, a layer of lithium that has been moved to a position between the negative electrode collector layer 20 and the solid electrolyte layer 40 from the positive electrode layer 60 side through the solid electrolyte layer 40 functions as the negative electrode layer 30. Note that the negative electrode layer 30 thus formed sometimes remains between the negative electrode collector layer 20 and the5 solid electrolyte layer 40 even after discharging.

### EXAMPLE

Hereinafter, the present invention will be described in further detail based on Example. However, the present invention is not limited to the following Example unless the gist is exceeded.

The present inventors produced two types of lithium-ion rechargeable batteries 1 (Example and Comparative example), and made evaluation about the structure and discharge capacity of each of the batteries.

Here, in Example, the lithium-ion rechargeable battery 1 having the lamination structure described in the above exemplary embodiment (refer to FIG. 1) was used. That is, in Example, the lithium-ion rechargeable battery 1 formed by laminating the negative electrode collector layer 20, the negative electrode layer 30, the solid electrolyte layer 40, (the mixture layer 50), the positive electrode layer 60 and the positive electrode collector layer 70 on the substrate 10 in this order was used.

On the other hand, in Comparative example, the lithium-ion rechargeable battery 1 formed by laminating the positive electrode collector layer 70, the positive electrode layer 60, the solid electrolyte layer 40, the negative electrode layer 30 and the negative electrode collector layer 20 on the substrate 10 in this order was used. Consequently, between Example and Comparative example, the order of laminating the respective layers on the substrate 10 is different. Moreover, though the details will be described later, as a result of changing the order of lamination, the lithium-ion rechargeable battery 1 in Comparative example is different from the lithium-ion rechargeable battery 1 in Example in the point that there is no mixture layer 50 between the solid electrolyte layer 40 and the positive electrode layer 60.

### [Method for Producing Lithium-Ion Rechargeable Battery in Example]

Now, the method for producing the lithium-ion rechargeable battery 1 in Example will be described.

Table 1 shows preparation conditions of the lithium-ion rechargeable battery 1 in Example. To described more specifically, Table 1 shows relationship between the name of each component of the lithium-ion rechargeable battery 1 in Example and the configuration (the material, thickness and structure) of each component. However, since the mixture layer 50 provided to the lithium-ion rechargeable battery 1 of Example is secondarily generated in laminating the positive electrode layer 60 on the solid electrolyte layer 40, description thereof is omitted here.

TABLE 1

| EXAMPLE | | | |
|---|---|---|---|
| COMPONENT | CONFIGURATION | | |
| NAME | MATERIAL | THICKNESS | STRUCTURE |
| POSITIVE | Pt | 150 nm | CRYSTALLINE |
| ELECTRODE | (TARGET) | | |
| COLLECTOR | | | |
| LAYER | | | |
| POSITIVE | LiNiO₂ + Li₃PO₄ | 137 nm | CRYSTALLINE + |
| ELECTRODE | (TARGET) | | AMORPHOUS |
| LAYER | | | |
| SOLID | LiPON | 600 nm | AMORPHOUS |
| ELECTROLYTE | (TARGET) | | |
| LAYER | | | |
| NEGATIVE | Si(B) | 200 nm | AMORPHOUS |
| ELECTRODE | (TARGET) | | |
| LAYER | | | |
| NEGATIVE | Ti | 300 nm | CRYSTALLINE |
| ELECTRODE | (TARGET) | | |
| COLLECTOR | | | |
| LAYER | | | |
| SUBSTRATE | SUS | 100 μm | CRYSTALLINE |

In Example, stainless steel (referred to as “SUS” in the table, and the same applies hereinafter) was used as the substrate 10. The thickness of the substrate 10 was set to 100 μm.

In Example, the negative electrode collector layer 20 was formed by using the sputtering method. In forming the negative electrode collector layer 20, as the sputtering target, titanium (Ti) was used (referred to as (Target) in the table, and the same applies hereinafter).

In the negative electrode collector layer formation process, deposition was performed by the DC sputtering method. At this time, the atmosphere in the chamber was Ar, the gas pressure in the chamber was 0.8 Pa, and the sputtering power was 500 W. Then, the deposition time was set so that the thickness of the negative electrode collector layer 20 became 300 nm.

In Example, the negative electrode layer 30 was formed by using the sputtering method. In forming the negative electrode layer 30, as the sputtering target, silicon (Si) added with boron (B) was used. Note that, in Table 1, represented as “Si(B).”

In the negative electrode layer formation process, deposition was performed by the DC sputtering method. At this time, the atmosphere in the chamber was Ar, the gas pressure in the chamber was 0.8 Pa, and the sputtering power was 500 W. Then, the deposition time was set so that the thickness of the negative electrode layer 30 became 200 nm.

Moreover, in Example, the solid electrolyte layer 40 was formed by using the sputtering method. In forming the solid electrolyte layer 40, as the sputtering target, LiPON, which was obtained by replacing a part of oxygen in phosphorylated lithium (Li₃PO₄) with nitrogen, was used.

In the solid electrolyte layer formation process, deposition was performed by the AC sputtering method. At this time, the atmosphere in the chamber was N₂, the gas pressure in the chamber was 0.5 Pa, and the sputtering power was 500 W. Then, the deposition time was set so that the thickness of the solid electrolyte layer 40 became 600 nm.

Moreover, in Example, the positive electrode layer 60 was formed by using the sputtering method. In forming the positive electrode layer 60, as the sputtering target, a mixture (a composite target) of phosphorylated lithium (Li₃PO₄) containing lithium (Li), phosphorous (P) and oxygen (O) and lithium nickel oxide (LiNiO₂) containing lithium (Li), nickel (Ni) and oxygen (O) was used.

In the positive electrode layer formation process, deposition was performed by the DC sputtering method. At this time, the atmosphere in the chamber was Ar/O₂, the gas pressure in the chamber was 0.5 Pa, and the sputtering power was 500 W. Then, the deposition time was set so that the thickness of the positive electrode layer 60 became 137 nm. Note that, in Example, the mixture layer 50 is also formed during this time; however, details thereof will be described later.

Moreover, in Example, the positive electrode collector layer 70 was formed by using the sputtering method. In forming the positive electrode collector layer 70, as the sputtering target, platinum (Pt) was used.

In the positive electrode collector layer formation process, deposition was performed by the DC sputtering method. At this time, the atmosphere in the chamber was Ar, the gas pressure in the chamber was 0.8 Pa, and the sputtering power was 500 W. Then, the deposition time was set so that the thickness of the positive electrode collector layer 70 became 150 nm.

### [Method for Producing Lithium-Ion Rechargeable Battery in Comparative Example]

Subsequently, the method for producing the lithium-ion rechargeable battery 1 in Comparative example will be described.

Table 2 shows production conditions of the lithium-ion rechargeable battery 1 in Comparative example. To described more specifically, Table 2 shows relationship between the name of each component of the lithium-ion rechargeable battery 1 in Comparative example and the configuration (the material, thickness and structure) of each component.

TABLE 2

| COMPARATIVE | | | |
|---|---|---|---|
| EXAMPLE | | | |
| COMPONENT | CONFIGURATION | | |
| NAME | MATERIAL | THICKNESS | STRUCTURE |
| NEGATIVE | Ti | 350 nm | CRYSTALLINE |
| ELECTRODE | (TARGET) | | |
| COLLECTOR | | | |
| LAYER | | | |
| NEGATIVE | Si(B) | 200 nm | AMORPHOUS |
| ELECTRODE | (TARGET) | | |
| LAYER | | | |
| SOLID | LiPON | 600 nm | AMORPHOUS |
| ELECTROLYTE | (TARGET) | | |
| LAYER | | | |
| POSITIVE | LiNiO₂ + Li₃PO₄ | 137 nm | CRYSTALLINE + |
| ELECTRODE | (TARGET) | | AMORPHOUS |
| LAYER | | | |
| POSITIVE | Ti | 300 nm | CRYSTALLINE |
| ELECTRODE | (TARGET) | | |
| COLLECTOR | | | |
| LAYER | | | |
| SUBSTRATE | SUS | 100 μm | CRYSTALLINE |

In Comparative example, stainless steel was also used as the substrate 10. Here, the thickness of the substrate 10 was set to 100 μm, which is same as that of Example.

Moreover, in Comparative example, the positive electrode collector layer 70 was formed by using the sputtering method. In forming the positive electrode collector layer 70, as the sputtering target, titanium (Ti) was used. Note that the production conditions of the positive electrode collector layer 70 were basically the same as those of the negative electrode collector layer 20 in Example.

Moreover, in Comparative example, by using the sputtering method, the positive electrode layer 60, the solid electrolyte layer 40, the negative electrode layer 30 and the negative electrode collector layer 20 were formed in this order. Here, the production conditions of the positive electrode layer 60, the solid electrolyte layer 40, the negative electrode layer 30 and the negative electrode collector layer 20 were basically the same as those of Example.

### [Evaluation of Lithium-Ion Rechargeable Battery]

Here, as criteria for evaluating the respective lithium-ion rechargeable batteries 1 in Example and Comparative example, the structure and the charge-discharge characteristics of both lithium-ion rechargeable batteries 1 were used.

### (Structure of Lithium-Ion Rechargeable Battery in Example)

First, the structure of the lithium-ion rechargeable battery 1 in Example will be described.

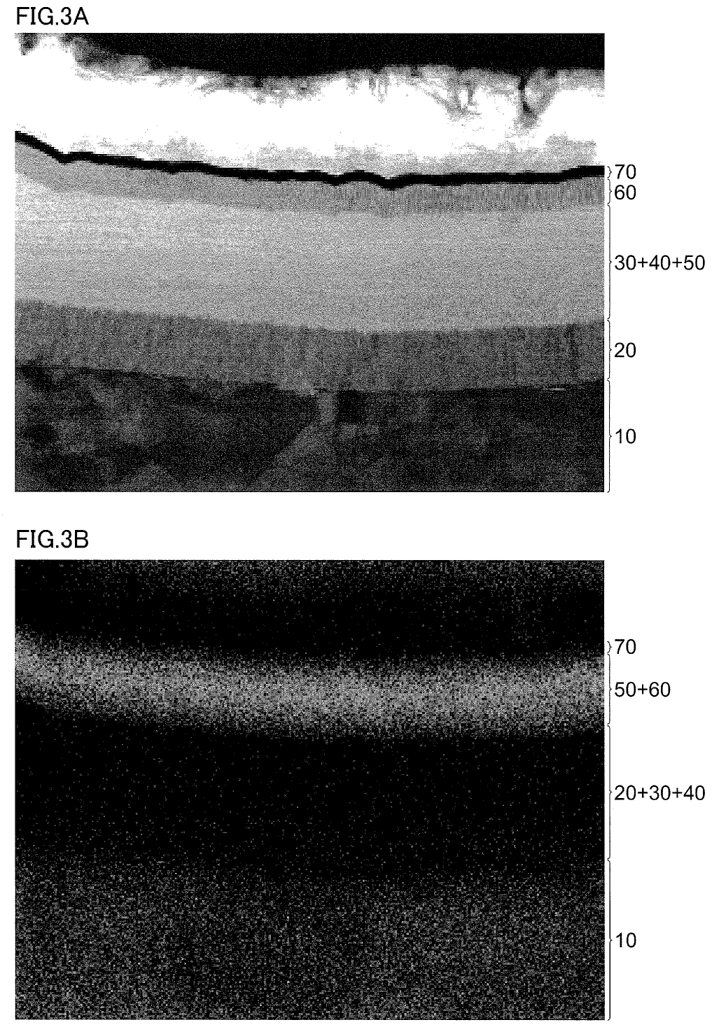

FIG. 3 shows diagrams for illustrating the structure of the lithium-ion rechargeable battery 1 in Example. Here, FIG. 3A shows a cross-sectional STEM (scanning transmission electron microscope) image of the lithium-ion rechargeable battery 1 in Example. FIG. 3B shows elemental mapping of nickel (Ni) in the lithium-ion rechargeable battery 1 in Example. Note that FIGS. 3A and 3B show the results obtained by taking photographs of the same region in the lithium-ion rechargeable battery 1 in Example. FIG. 3B was obtained by EDX (Energy Dispersive X-ray Spectrometry).

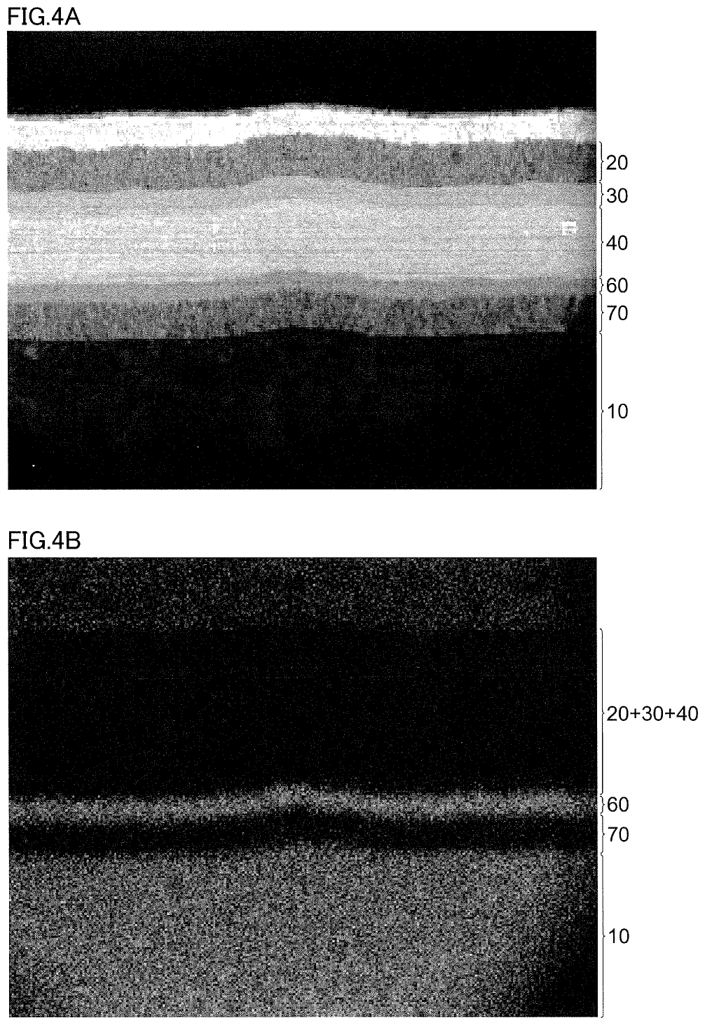

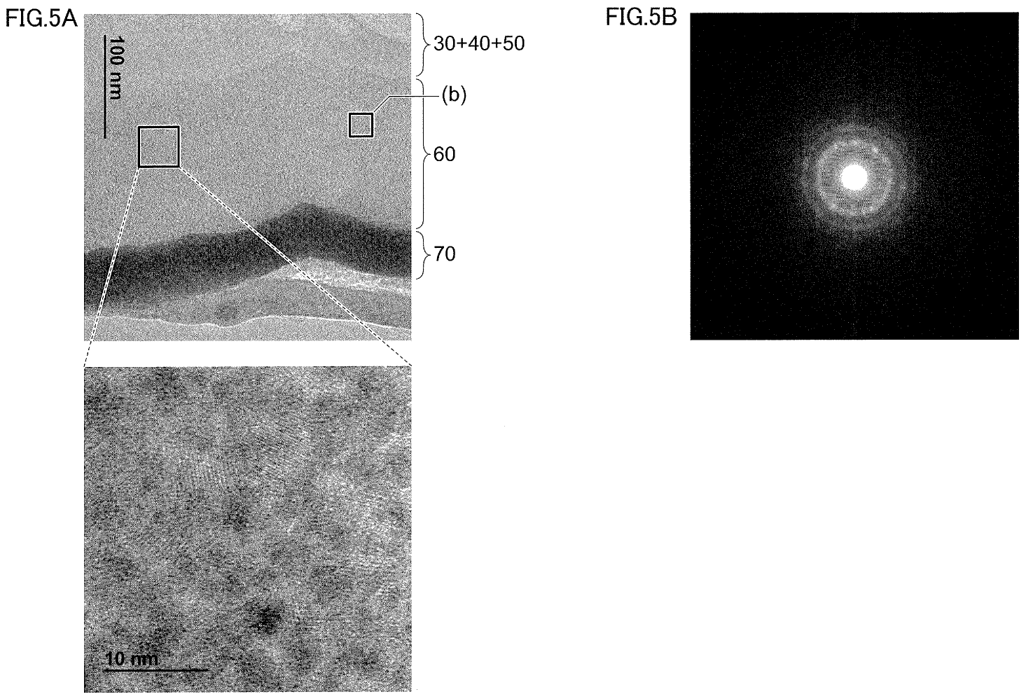

These images (photographs) were taken by use of Ultra-thin Film Evaluation System HD-2300 manufactured by Hitachi High-Technologies Corporation (the same is true for FIGS. 4 and 5 to be described later). Here, STEM has characteristics capable of obtaining an image reflecting composition information. To describe more specifically, in the STEM, a region where heavy elements exist is expressed as relatively blackish, and a region where light elements exist is expressed as relatively whitish. Moreover, in this specific example, as the analysis result by EDX, a region where the element to be the target of mapping (here, nickel (Ni)) exists is expressed more whitish than a region where the element does not exist.

In FIG. 3A, the lowest black layer is the substrate 10 made of stainless steel (SUS). Moreover, the layer of a dark gray color existing directly above the substrate 10 is the negative electrode collector layer 20 made of titanium (Ti). On the other hand, the black layer existing on the upper side is the positive electrode collector layer 70 made of platinum (Pt). In addition, the layer of a dark gray color existing directly below the positive electrode collector layer 70 is the positive electrode layer 60 containing phosphorylated lithium (Li₃PO₄) and lithium nickel oxide (LiNiO₂). Here, the negative electrode layer 30 and the solid electrolyte layer 40 exist between the negative electrode collector layer 20 and the positive electrode layer 60; however, in FIG. 3A, since these regions are in the layers of the same color (light gray), it is difficult to distinguish these layers. Moreover, from FIG. 3A, it is impossible to determine whether or not the mixture layer 50 exists between the solid electrolyte layer 40 and the positive electrode layer 60. However, in FIG. 3A, the light gray layer is referred to as “30+40+50.”

On the other hand, as is clear from FIG. 3B, nickel (Ni) is unevenly distributed at the lowest and on the upper side. Here, in the lithium-ion rechargeable battery 1 in Example, nickel (Ni) is capable of existing in at least the substrate 10 and the positive electrode layer 60. This is because stainless steel (SUS) constituting the substrate 10 contains nickel (Ni) and lithium nickel oxide (LiNiO₂) constituting the positive-electrode active material in the positive electrode layer 60 contains nickel (Ni).

Here, by comparing FIGS. 3A and 3B, it can be understood that nickel (Ni) existing at the lowest corresponds to the substrate 10. In contrast thereto, from the fact that the thickness of nickel (Ni) existing on the upper side in FIG. 3B is larger (thicker) than the thickness of the positive electrode layer 60 shown in FIG. 3A, it is learned that nickel (Ni) exists in the layers other than the positive electrode layer 60. From these, it is suggested that a region of the light gray layer indicated by “30+40+50” in FIG. 3A, which is adjacent to the positive electrode layer 60, is a layer containing nickel (Ni). In other words, it can be understood that the region is the mixture layer 50 containing the inorganic solid electrolyte and the positive-electrode active material.

### (Structure of Lithium-Ion Rechargeable Battery in Comparative Example)

Subsequently, the structure of the lithium-ion rechargeable battery 1 in Comparative example will be described.

FIG. 4 shows diagrams for illustrating the structure of the lithium-ion rechargeable battery 1 of Comparative example. Here, FIG. 4A is a cross-sectional STEM image of the lithium-ion rechargeable battery 1 in Comparative example. FIG. 4B shows elemental mapping of nickel (Ni) in the lithium-ion rechargeable battery 1 in Comparative example. Note that

FIGS. 4A and 4B show the results obtained by taking photographs of the same region in the lithium-ion rechargeable battery 1 in Comparative example. Moreover, FIG. 4B is obtained by EDX.

From FIG. 4A, it can be learned that the substrate 10, the positive electrode collector layer 70, the positive electrode layer 60, the solid electrolyte layer 40, the negative electrode layer 30 and the negative electrode collector layer 20 are laminated in this order in the lithium-ion rechargeable battery 1 in Comparative example.

On the other hand, as is clear from FIG. 4B, nickel (Ni) is unevenly distributed at the lowest and on the middle side. Here, in the lithium-ion rechargeable battery 1 in Comparative example, nickel (Ni) is also capable of existing in at least the substrate 10 and the positive electrode layer 60.

Here, by comparing FIGS. 4A and 4B, it can be understood that nickel (Ni) existing at the lowest corresponds to the substrate 10. Moreover, from the fact that the thickness of nickel (Ni) existing on the middle side in FIG. 4B is equal to the thickness of the positive electrode layer 60 shown in FIG. 4A, it is learned that nickel (Ni) corresponds to the positive electrode layer 60. Consequently, different from Example, it can be understood that the mixture layer 50 does not exist between the solid electrolyte layer 40 and the positive electrode layer 60 in Comparative example.

### (Crystal Structure of Lithium-Ion Rechargeable Battery in Example)

Next, with reference to Table 1, description will be given of the crystal structure of the lithium-ion rechargeable battery 1 in Example.

An analysis by the X-ray diffraction performed on the lithium-ion rechargeable battery 1 in Example showed that the substrate 10, the negative electrode collector layer 20 and the positive electrode collector layer 70 were crystallized. The negative electrode layer 30 and the solid electrolyte layer 40 were amorphized. In contrast thereto, in the positive electrode layer 60, crystallized regions and amorphized regions were mixed. Note that, though not described in Table 1, similar to the positive electrode layer 60, crystallized regions and amorphized regions were also mixed in the mixture layer 50.

(Crystal structure of lithium-ion rechargeable battery in Comparative Example)

Moreover, with reference to Table 2, description will be given of the crystal structure of the lithium-ion rechargeable battery 1 in Comparative example.

An analysis by the X-ray diffraction performed on the lithium-ion rechargeable battery 1 in Comparative example showed that the substrate 10, the negative electrode collector layer 20 and the positive electrode collector layer 70 were crystallized. The negative electrode layer 30 and the solid electrolyte layer 40 were amorphized. In contrast thereto, in the positive electrode layer 60, crystallized regions and amorphized regions were mixed.

### (Structure of Positive Electrode Layer of Lithium-Ion Rechargeable Battery in Example)

FIG. 5 shows diagrams for illustrating the structure of the positive electrode layer 60 of the lithium-ion rechargeable battery 1 in Example. Here, FIG. 5A shows cross-sectional STEM images of the lithium-ion rechargeable battery 1 in Example: the upper side shows a lamination state of the positive electrode layer 60 and surroundings thereof, and the lower side shows an enlarged state of a partial region in the positive electrode layer 60. Moreover, FIG. 5B shows an electron diffraction photograph of the region (b) shown in the upper side in FIG. 5A.

As shown in the lower side in FIG. 5A, the positive electrode layer 60 in Example is in a state of mixture of regions expressed as relatively whitish and regions expressed as relatively blackish. This means that the positive electrode layer 60 in Example is configured with a mixed material of a region containing relatively light elements, namely, the solid electrolyte region 61 containing no transition metal, and a region containing relatively heavy elements, namely, the positive electrode region 62 containing the transition metal.

Moreover, as shown in the lower side in FIG. 5A, the positive electrode layer 60 in Example is in a state where the solid electrolyte region 61 expressed as relatively whitish serves as the base material and the positive electrode region 62 expressed as relatively blackish is dispersed therein as the particles.

In FIG. 5B, a halo pattern and diffraction spots are seen; also from this, it can be understood that the crystallized regions and the amorphized regions are mixed in the positive electrode layer 60.

### (Charge-Discharge Characteristics)

The charge-discharge characteristics were measured for each of the lithium-ion rechargeable batteries 1 in Example and Comparative example. As a measuring device of the charge-discharge characteristics, Battery Charge/Discharge System HJ1020mSD8 manufactured by HOKUTO DENKO CORPORATION was used. Here, the current in charging (charge current) and the current in discharging (discharge current) were 160 (μA), 640 (μA), 1280 (μA), 2560 (μA) and 5120 (μA) in each.

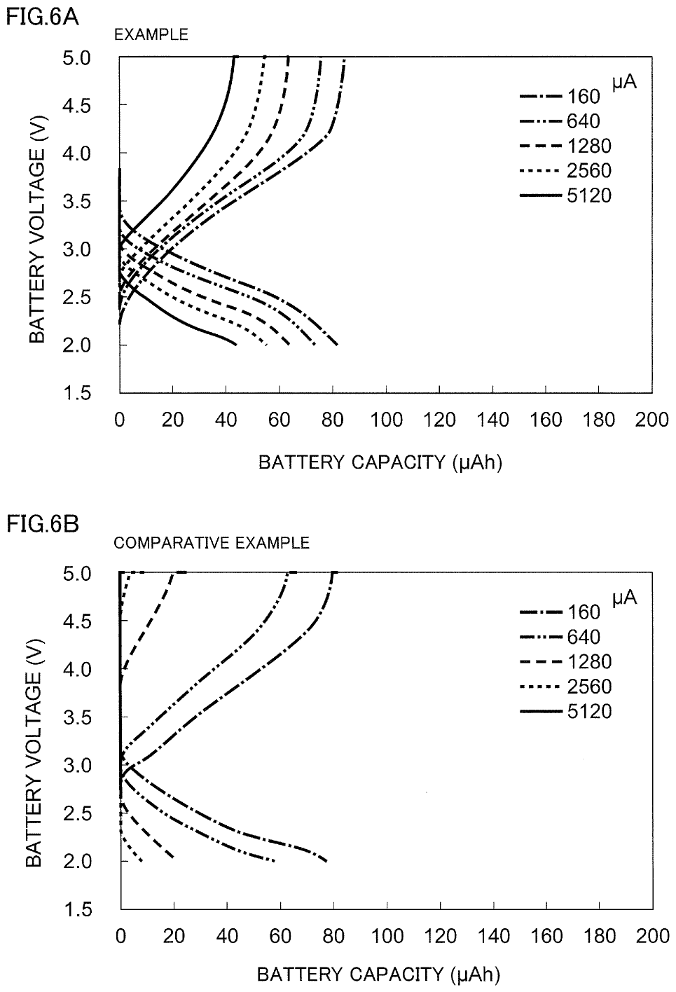

FIG. 6A is a diagram showing the charge-discharge characteristics of the lithium-ion rechargeable battery 1 in Example. Moreover, FIG. 6B is a diagram showing the charge-discharge characteristics of the lithium-ion rechargeable battery 1 in Comparative example. Here, in each of FIGS. 6A and 6B, the horizontal axis indicates the battery capacity (μAh), and the vertical axis indicates the battery voltage (V). Moreover, in each of FIGS. 6A and 6B, a positively sloped curve in the figure indicates the charge characteristics, and a negatively sloped curve in the figure indicates the discharge characteristics.

In the respective lithium-ion rechargeable batteries 1 in Example and Comparative example, the negative electrode layer 30, the solid electrolyte layer 40 and the positive electrode layer 60 are basically configured with the same material and have the same thickness. However, as is clear from FIGS. 6A and 6B, the battery voltage in Comparative example sharply increases in the case of increasing the charge current, as compared to Example. As a result, in Comparative example, the battery capacity at the completion of charging is smaller than that in Example. Moreover, in Comparative example, the battery voltage sharply decreases in discharging, as compared to Example. As described above, in Example, the battery capacity, namely, the charge capacity and discharge capacity are increased as compared to Comparative example.

Moreover, in Example, charging and discharging can be performed even in the case where the charge current value is increased to 5120 (μA), whereas, in contrast thereto, charging and discharging are practically impossible in the case where the charge current value is set to 5120 (μA) in Comparative example.

It can be considered that the aforementioned difference results from the internal resistance of the lithium-ion rechargeable battery 1 in Example lower than that in Comparative example. Then, it can be considered that, in the lithium-ion rechargeable battery 1 in Example, since the mixture layer 50 is provided at the boundary portion between the solid electrolyte layer 40 and the positive electrode layer 60, the internal resistance is lower than that in Comparative example including no mixture layer 50.

### REFERENCE SIGNS LIST

1 Lithium-ion rechargeable battery
10 Substrate
20 Negative electrode collector layer
30 Negative electrode layer
40 Solid electrolyte layer
50 Mixture layer
60 Positive electrode layer
61 Solid electrolyte region
62 Positive electrode region
70 Positive electrode collector layer
   1-9. (canceled).

10. A method for producing a lithium-ion rechargeable battery, comprising:
a solid electrolyte layer formation process forming a solid electrolyte layer containing an inorganic solid electrolyte having lithium-ion conductivity; and
a positive electrode layer formation process implanting a positive-electrode active material into the solid electrolyte layer and forming a positive electrode layer containing the inorganic solid electrolyte and the positive-electrode active material in mixture on the solid electrolyte layer.

11. The method for producing a lithium-ion rechargeable battery according to claim 10, wherein a ratio of the positive-electrode active material in the solid electrolyte layer is lower than a ratio of the positive-electrode active material in the positive electrode layer.

12. The method for producing a lithium-ion rechargeable battery according to claim 10, wherein
the inorganic solid electrolyte contains LiₓP_{y}O_{z} (x≠0, z≠0), and
the positive-electrode active material contains LiₐM_{b}O_{c} (M is a transition metal, a≠0, b≠0, c≠0).

13. The method for producing a lithium-ion rechargeable battery according to claim 11, wherein
the inorganic solid electrolyte contains LiₓP_{y}O_{z} (x≠0, y≠0, z≠0), and
the positive-electrode active material contains LiₐM_{b}O_{c} (M is a transition metal, a≠0, b≠0, c≠0).

14. The method for producing a lithium-ion rechargeable battery according to claim 10, wherein the positive-electrode active material contains an element heavier than an element contained in the inorganic solid electrolyte.

15. The method for producing a lithium-ion rechargeable battery according to claim 11, wherein the positive-electrode active material contains an element heavier than an element contained in the inorganic solid electrolyte.

16. The method for producing a lithium-ion rechargeable battery according to claim 12, wherein the positive-electrode active material contains an element heavier than an element contained in the inorganic solid electrolyte.

17. The method for producing a lithium-ion rechargeable battery according to claim 13, wherein the positive-electrode active material contains an element heavier than an element contained in the inorganic solid electrolyte.

18. A lithium-ion rechargeable battery comprising:
a solid electrolyte layer containing an inorganic solid electrolyte having lithium-ion conductivity;
a mixture layer containing a positive-electrode active material and the inorganic solid electrolyte in mixture; and
a positive electrode layer containing the positive-electrode active material and the inorganic solid electrolyte in mixture, a ratio of the positive-electrode active material in the positive electrode layer being higher than a ratio of the positive-electrode active material in the mixture layer.

19. The lithium-ion rechargeable battery according to claim 18, wherein the inorganic solid electrolyte contains LiₓP_{y}O_{z} (x≠0, y≠0, z≠0), and the positive-electrode active material contains LiₐM_{b}O_{c} (M is a transition metal, a≠0, b≠0c≠0).

20. The lithium-ion rechargeable battery according to claim 19, wherein, in the positive electrode layer, the positive-electrode active material is crystallized and the inorganic solid electrolyte is amorphized.

21. The lithium-ion rechargeable battery according to claim 19, wherein, in the positive electrode layer, particles composed of the positive-electrode active material are dispersed into a base material composed of the inorganic solid electrolyte.

22. The lithium-ion rechargeable battery according to claim 20, wherein, in the positive electrode layer, particles composed of the positive-electrode active material are dispersed into a base material composed of the inorganic solid electrolyte.

23. The lithium-ion rechargeable battery according to claim 19, wherein the positive electrode layer contains the LiₐM_{b}O_{c} more than the LiₓP_{y}O_{z} in a molar ratio.

24. The lithium-ion rechargeable battery according to claim 20, wherein the positive electrode layer contains the LiₐM_{b}O_{c} more than the Li_{c}P_{y}O_{z} in a molar ratio.

25. The lithium-ion rechargeable battery according to claim 21, wherein the positive electrode layer contains the LiₐM_{b}O_{c} more than the LiₓP_{y}O_{z} in a molar ratio.

26. The lithium-ion rechargeable battery according to claim 22, wherein the positive electrode layer contains the LiₐM_{b}O_{c} more than the LiₓP_{y}O_{z} in a molar ratio.
